(19) United States
(12) Patent Application Publication
(10) Pub. No.: US 2026/0121305 A1
(43) Pub. Date: Apr. 30, 2026

(54) ARRAY ANTENNA STRUCTURE AND ARRAY ANTENNA MODULE

(71) Applicant: Panasonic Intellectual Property Management Co., Ltd., Osaka (JP)

(72) Inventors: NORIHITO TSUKAHARA, Kyoto (JP); MASATO MORI, Hyogo (JP); TAKAYUKI SOTOYAMA, Kanagawa (JP); NAOKI ADACHI, Kanagawa (JP)

(21) Appl. No.: 19/432,053

(22) Filed: Dec. 23, 2025

Related U.S. Application Data
(63) Continuation of application No. PCT/JP2024/018908, filed on May 22, 2024.

(30) Foreign Application Priority Data
Jul. 12, 2023 (JP) 2023-114663

(51) Int. Cl. H01Q 21/06; H01Q 1/38; H01Q 9/04

(52) U.S. Cl. CPC H01Q 21/065; H01Q 1/38; H01Q 9/0407

(57) ABSTRACT

The array antenna structure includes first antenna structure (20) and second antenna structure (30). First antenna structure (20) includes power supply control board (3) having an L-shaped structure cut out by a length R in the X direction and a length S in the Z direction on a right side with respect to the center line in the X direction. Second antenna structure (30) includes power supply control board (3) having an L-shaped structure cut out by a length R in the X direction and a length S in the Z direction on a left side with respect to the center line in the X direction.

### DESCRIPTION

### TECHNICAL FIELD

The present disclosure relates to an array antenna structure and an array antenna module.

### BACKGROUND ART

In recent years, commercial services using fifth generation (5G) mobile communication systems have started, and 5G systems are expected to further accelerate sophistication of multimedia services and provide new value as an infrastructure technology that supports industries or society.

5G is a mobile communication system that handles a high frequency band higher than 10 GHz, such as millimeter waves. As transmission and reception antennas of such systems, patch antennas (microstrip antennas) are generally used. A patch antenna is a type of planar antenna including, as components thereof, a dielectric substrate, radiation elements that are formed as wiring on respective surfaces of the dielectric substrate, and a ground conductor plate.

In order to achieve an intended radiation directionality (radiation pattern), a multi-element array antenna including a plurality of patch antennas that are regularly arranged in a straight line or a plane is often used.

In addition, the multi-element array antenna enables large-capacity communication.

Antenna elements, such as patch antennas, form an antenna structure (that is, antenna module) by being connected to various types of signal processing circuits or power feed circuits.

Then, the antenna structure is housed in a housing such as a case or a cover, and is practically used as an antenna unit for communication.

For example, PTL 1 discloses an antenna structure and an antenna unit that each include an antenna element part, and a circuit part that amplifies an electric signal converted by the antenna element part.

The antenna element part and the circuit part are configured as separate bodies, and together form an antenna unit by being connected to each other by a cable and housed in an external case in a manner disposed side by side.

In recent years, when the size of the antenna unit increases, a place where the antenna unit is installed is limited, and thus there is a strong demand for miniaturization.

However, in the structure of the antenna structure of PTL 1 in which the antenna element part and the circuit part are arranged side by side, it is necessary to secure an area in which the antenna element part and the circuit part are provided side by side in a planar direction, and thus miniaturization is difficult.

Therefore, in order to realize miniaturization of the antenna unit, for example, PTL 2 discloses an antenna structure including an antenna element part including a ground conductor and an antenna pattern formed on an upper surface of the ground conductor via a first dielectric substrate, and a circuit part including a circuit pattern formed on a lower surface of the ground conductor via a second dielectric substrate and a circuit component to be mounted.

### Citation List

### Patent Literature

PTL 1: Unexamined Japanese Utility Model Publication No. H06-041220

PTL 2: Unexamined Japanese Patent Publication No. H06-152237

### SUMMARY OF THE INVENTION

An array antenna structure according to one aspect of the present disclosure includes: two or more m antenna structures including a first antenna structure and a second antenna structure, in which each of the first antenna structure and the second antenna structure is configured as an antenna structure in which an antenna board having n patch antenna elements formed in an X direction at an interval P, and having a length L in the X direction arranged on an XY plane, and a power supply control board having a length Q in the X direction and a thickness T arranged on an XZ plane are connected by a connection member including a joint electrode on a surface of an insulating resin such that a center line of each of the antenna board and the power supply control board in the X direction coincides with each other with the X direction as a longitudinal direction, the first antenna structure and the second antenna structure are arranged adjacent to each other in a Y direction of the XY plane, the power supply control board of the first antenna structure includes an L-shaped structure having a notch cut out by a length R in the X direction and a length S in the Z direction on a right side with respect to the center line in the X direction when viewed from a -Y direction, the power supply control board of the second antenna structure includes an L-shaped structure having a notch cut out by a length R in the X direction and a length S in the Z direction on a left side with respect to the center line in the X direction when viewed from the -Y direction, and the power supply control board of the first antenna structure and the power supply control board of the second antenna structure are arranged such that each notch faces an XZ region of an adjacent power supply control board.

### BRIEF DESCRIPTION OF THE DRAWINGS

FIG. 1A is a schematic diagram illustrating an example of a first antenna structure according to a first exemplary embodiment.

FIG. 1B is a schematic diagram of an example of the first antenna structure according to the first exemplary embodiment as viewed from the right side to the left side in the Y direction.

FIG. 1C is a schematic diagram of an example of the first antenna structure according to the first exemplary embodiment as viewed from the front side to the back side in the X direction.

FIG. 2A is a schematic diagram illustrating an example of another second antenna structure according to the first exemplary embodiment.

FIG. 2B is a schematic diagram of an example of the second antenna structure according to the first exemplary embodiment as viewed from the right side to the left side in the Y direction.

FIG. 2C is a schematic diagram of an example of the second antenna structure according to the first exemplary embodiment as viewed from the front side to the back side in the X direction.

FIG. 3A is a schematic diagram illustrating an example of an array antenna structure according to the first exemplary embodiment.

FIG. 3B is a schematic diagram of an example of the array antenna structure according to the first exemplary embodiment as viewed from the upper side to the lower side in the Z direction.

FIG. 3C is a schematic diagram of an example of the array antenna structure according to the first exemplary embodiment as viewed from the lower side to the upper side in the Z direction.

FIG. 4A is a schematic diagram of an example of the antenna structure according to the first exemplary embodiment as viewed in the -Y direction, that is, from the right side to the left side in the Y direction.

FIG. 4B is a schematic diagram of an example of another antenna structure according to the first exemplary embodiment as viewed in the -Y direction, that is, from the right side to the left side in the Y direction.

FIG. 5 is a schematic diagram of an example of an array antenna module according to the first exemplary embodiment as viewed from the lower side to the upper side in the Z direction.

### DESCRIPTION OF EMBODIMENT

In the structure of the antenna structure shown in PTL 2, even if the antenna element is downsized, the overall size of the antenna structure is determined by the mounting area of the circuit component mounted on the opposite surface side of the antenna element part of the dielectric substrate, and thus there is a problem that it is difficult to realize a small antenna structure having a mounting area less than or equal to the mounting area of the circuit component.

Furthermore, even in a case where an array antenna structure is formed by arranging a plurality of the antenna elements, because the interval at which the antenna elements are arranged is restricted by the area for mounting the circuit components, which are mounted on the dielectric substrate on the opposite surface side of the surface on which the antenna element part is disposed, it is difficult to achieve an array antenna structure in which a plurality of small antenna elements are arranged adjacently each other at a narrow pitch.

Furthermore, in such an array antenna structure, the antenna elements are usually arranged at an interval of a half wavelength of the communication frequency. However, for example, in a case where high-frequency communication, such as that at 39 GHz is demanded, the half wavelength of such a wavelength becomes 3.75 mm, which is extremely small. Therefore, it is even more challenging, with the structure of the antenna structure disclosed in PTL2, to arrange a plurality of antenna elements at a half wavelength of the communication wavelength.

As described above, an object of the present disclosure is to provide a small array antenna structure and an array antenna module compatible with high-frequency communication, the size of which is not restricted by the size or mounting area of circuit components constituting a signal circuit or a power feed circuit.

Hereinafter, an array antenna structure and an array antenna module according to exemplary embodiments of the present disclosure will be described with reference to the drawings.

Note that substantially the same members in the drawings are denoted by the same reference numerals.

### Exemplary embodiment

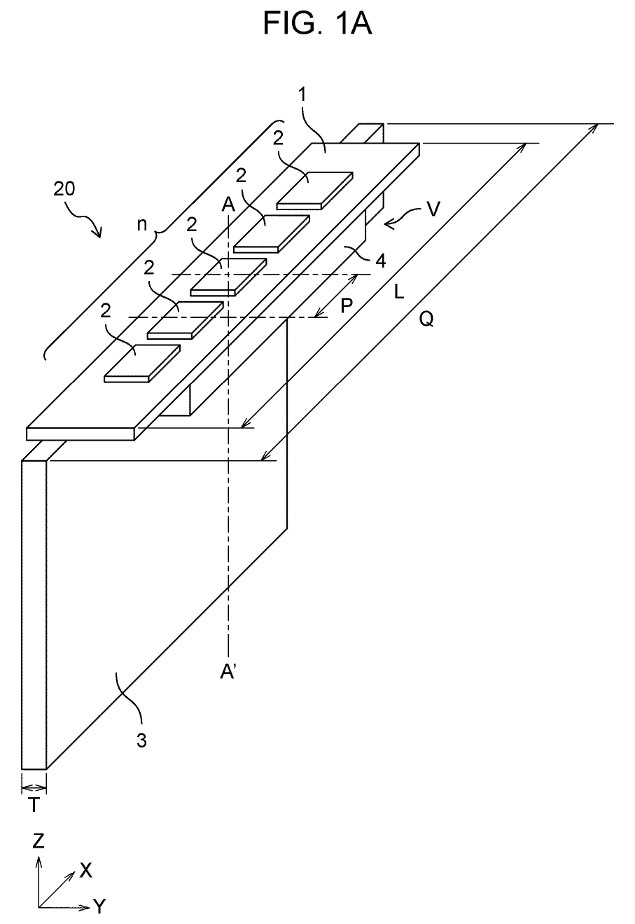

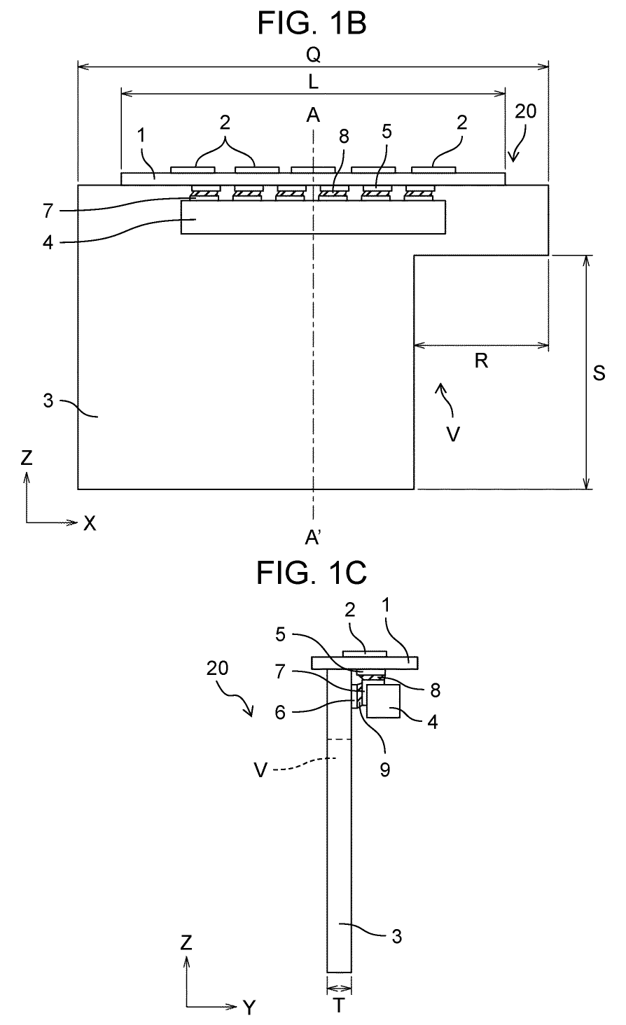

FIGS. 1A to 1C are each a schematic diagram illustrating an example of first antenna structure 20 according to a first exemplary embodiment. First antenna structure 20 includes antenna board 1, power supply control board 3, and connection member 4 that connects antenna board 1 and power supply control board 3. The three directions of XYZ are arranged so as to be orthogonal to each other.

In FIGS. 1A to 1C, antenna board 1 is disposed parallel to the XY plane, and the length in the X direction is L. On the surface of antenna board 1, one or more n patch antenna elements 2 are formed at equal intervals P in parallel with the X direction.

The interval P between patch antenna elements 2 is determined by the communication frequency of the device, and has a value of 1/2 of the wavelength. In the present first exemplary embodiment, as an example, since the communication frequency is 39GHz, 3.75 mm, which is a half wavelength thereof, is used.

In the present first exemplary embodiment, as an example, antenna board 1 is fabricated with a width of 3.5 mm, a length of 120 mm, and a thickness of 0.8 mm using a multilayer substrate material "MEGTRON 7" manufactured by Panasonic Corporation as a base material.

As an example, five patch antenna elements 2 each having a size of 2 mm × 2 mm are formed of a copper foil having a thickness of 18 μm, and are arranged at equal intervals P.

The number of patch antenna elements 2 to be fabricated may be an optimum number (n) depending on application of the antenna. Here, n is an integer of n > 0.

In addition, it is desirable that the n patch antenna elements 2 formed on the surface of antenna board 1 are arranged line-symmetrically with respect to center line A-A’ of antenna board 1 in the X direction. As described above, when array antenna structure 40 is formed by alternately arranging first antenna structure 20 and second antenna structure 30, if patch antenna elements 2 are arranged line-symmetrically with respect to the center line A-A’, it is possible to easily form n×m matrix-shaped array antennas only by aligning the end surfaces of power supply control board 3.

Furthermore, the material of antenna board 1 is not limited to “MEGTRON 7”, and other glass epoxy materials or ceramic materials may be used.

Joint electrode 5 for joining to joint electrode 7 of connection member 4 is formed on a surface of antenna board 1 on a side opposite to a surface on which patch antenna element 2 is formed.

Connection member 4 made of an insulating resin extends in the X direction and has a surface arranged in parallel with the XY plane and a surface arranged in parallel with the XZ plane. Joint electrode 7 for joining joint electrode 5 of antenna board 1 and joint electrode 6 of power supply control board 3 is formed on a surface arranged in parallel with the XY plane and a surface arranged in parallel with the XZ plane. In FIG. 1C, joint electrode 7 is arranged in an L shape so as to extend over a surface arranged in parallel with the XY plane and a surface arranged in parallel with the XZ plane.

As an example, connection member 4 has a width of 2.0 mm in the Y direction, a height of 2.0 mm in the Z direction, and a length of 80 mm in the X direction.

As a material of the insulating resin of connection member 4, as an example, LCP (liquid crystal polymer) having a dielectric constant of 4.3 and a dielectric loss tangent of 0.015 is used, but the material is not limited thereto, and may be PPA, ABS, PEEK, or PC.

Further, as an example, joint electrode 7 is formed by a plating method with an electrode having a thickness of Cu 10 μm/a thickness of Ni 0.2 μm/a thickness of Au 0.05 μm, but joint electrode 7 may be formed by printing of a conductive resin, dispensing coating, or the like, or other methods.

Joint electrode 7 forms first joining part 8 that is metal joined to joint electrode 5 of antenna board 1. In the present first exemplary embodiment, as an example, solder having a composition of Sn-3.0Ag-0.5Cu is used as a material for metal joining joint electrode 7 and joint electrode 5 of antenna board 1.

The joining material is not limited to solder, and other joining materials such as a conductive paste of Ag or Cu may be used.

Power supply control board 3 is disposed parallel to the XZ plane with a board thickness T and a length Q in the X direction, and joint electrode 6 formed on the surface of power supply control board 3 forms second joining part 9 metal joined to joint electrode 7 of connection member 4.

In the present first exemplary embodiment, Sn-Bi based solder is used for joining joint electrode 6 of power supply control board 3 and joint electrode 7 of connection member 4, but the present invention is not limited thereto.

In addition, each of first joining part 8 and second joining part 9 may have an integrated shape depending on a molten state of solder or the like which is a material for metal joining.

Power supply control board 3 has, on the right side with respect to center line A-A’ in the X direction when viewed from the -Y direction, rectangular notch V cut out by a length R in the X direction from a right end edge and a length S in the Z direction from a lower end edge. By having notch V in this manner, as described later, the electronic components of the adjacently arranged boards can be accommodated in notch V, and the restriction on the height of the electronic components can be alleviated.

In the present first exemplary embodiment, as an example, notch V has a length R of 50 mm in the X direction and a length S of 80 mm in the Z direction.

Although not illustrated, circuit components constituting a signal circuit or a power feed circuit are mounted on power supply control board 3. In the present first exemplary embodiment, as an example, the size of power supply control board 3 is set such that the length Q in the X direction is 150 mm, the length in the Z direction is 100 mm, and the thickness T in the X direction is 1.6 mm.

As illustrated in FIGS. 1A and 1B, antenna board 1 and power supply control board 3 are disposed such that center lines A-A’ of antenna board 1 and power supply control board 3 in the X direction coincide with each other, thereby forming first antenna structure 20.

In FIGS. 1A to 1C, as an example, a case is shown in which the relationship between the length L of antenna board 1 in the X direction and the length Q of power supply control board 3 in the X direction is L < Q, but the relationship is not limited thereto.

In consideration of ease of manufacturing when antenna board 1 and power supply control board 3 are joined via connection member 4, it is desirable that L = Q is satisfied, in which the alignment between antenna board 1 and power supply control board 3 can be easily performed by adjusting the end surfaces of the respective boards in the X direction. However, even if L < Q or L > Q is satisfied, there is no problem in manufacturing.

With the configuration having the above description, first antenna structure 20 is formed in which antenna board 1 disposed parallel to the XY plane and power supply control board 3 disposed parallel to the XZ plane are electrically connected via connection member 4.

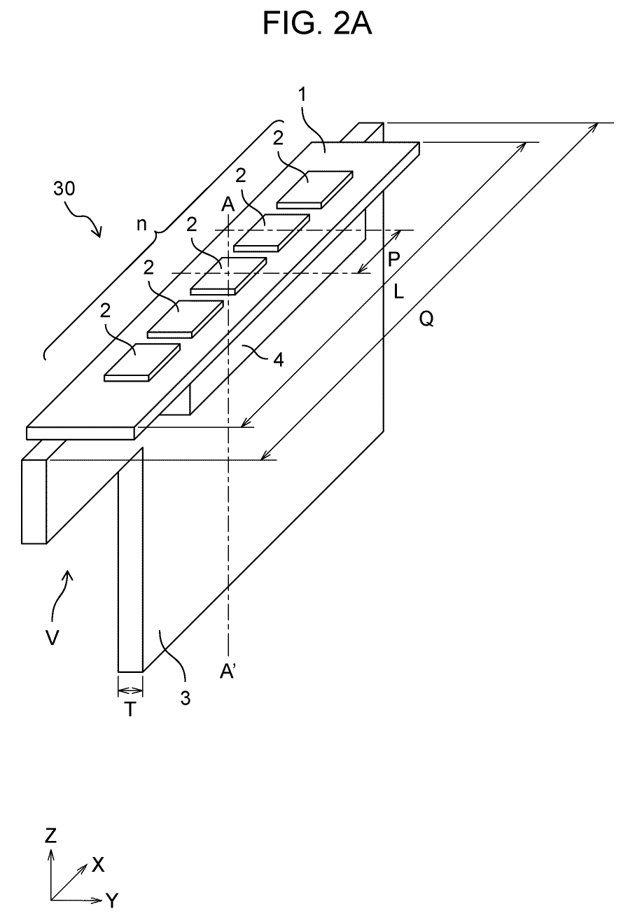

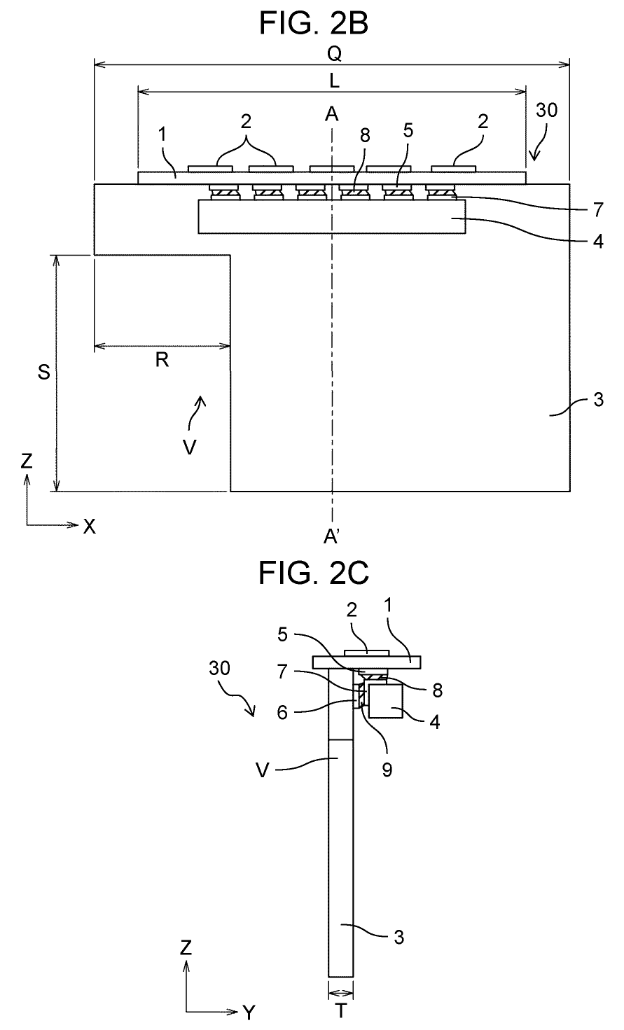

Next, a configuration of second antenna structure 30 different from first antenna structure 20 according to the first exemplary embodiment will be described with reference to FIGS. 2A to 2C.

Second antenna structure 30 is different from first antenna structure 20 in that, when viewed from the -Y direction, the second antenna structure has rectangular notch V cut out by a length R in the X direction from the left end edge and a length S in the Z direction from the lower end edge on the left side with respect to center line A-A’ in the X direction of power supply control board 3. Note that the material, size, and the like of power supply control board 3 or other constituent elements are similar to those of first antenna structure 20.

The components of other members such as antenna board 1 and connection member 4 of second antenna structure 30 are exactly the same as those of first antenna structure 20.

As illustrated in FIGS. 2A and 2B, antenna board 1 and power supply control board 3 are disposed such that center lines A-A’ of antenna board 1 and power supply control board 3 in the X direction coincide with each other, thereby forming second antenna structure 30.

With the configuration having the above description, second antenna structure 30 is formed in which antenna board 1 arranged in parallel with the XY plane and power supply control board 3 arranged in parallel with the XZ plane are electrically connected via connection member 4.

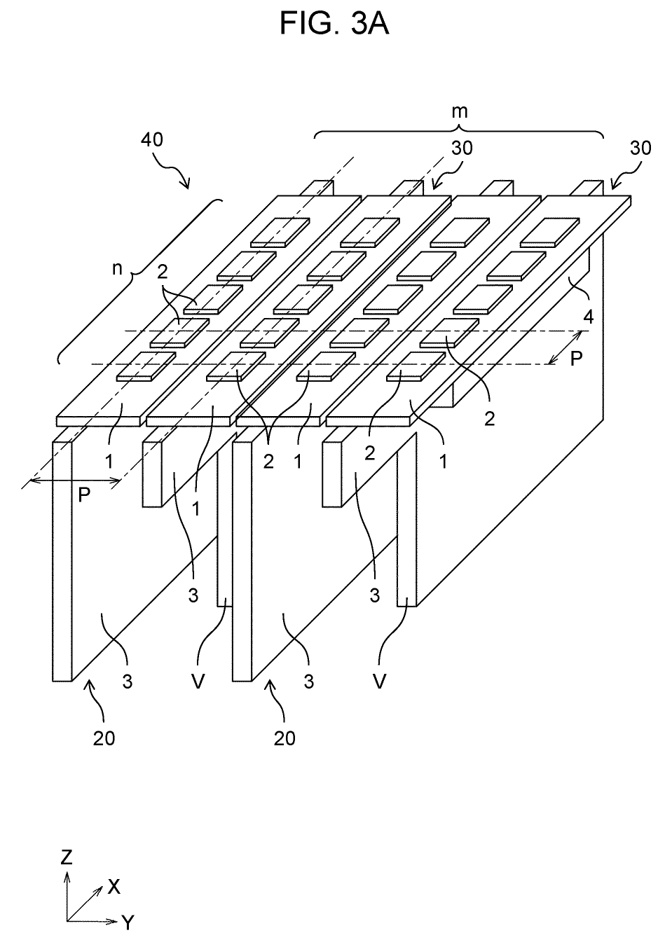

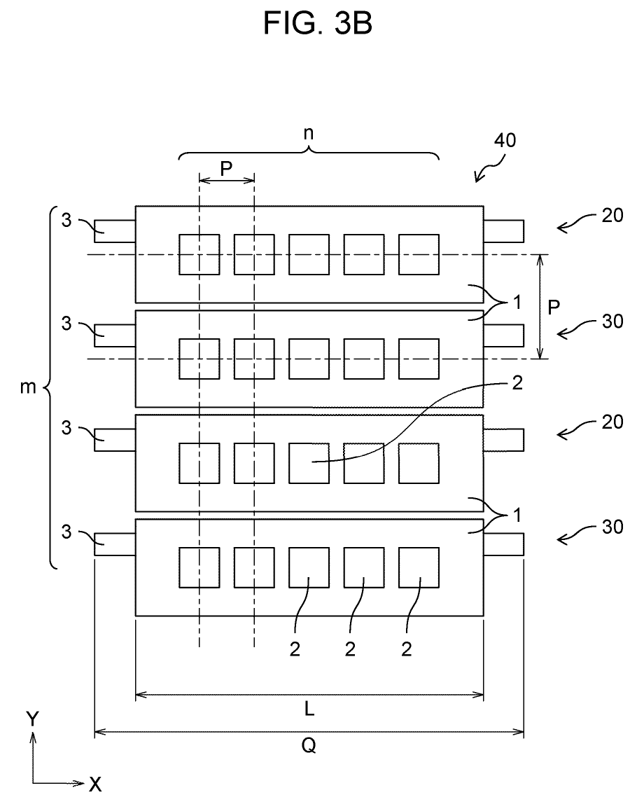

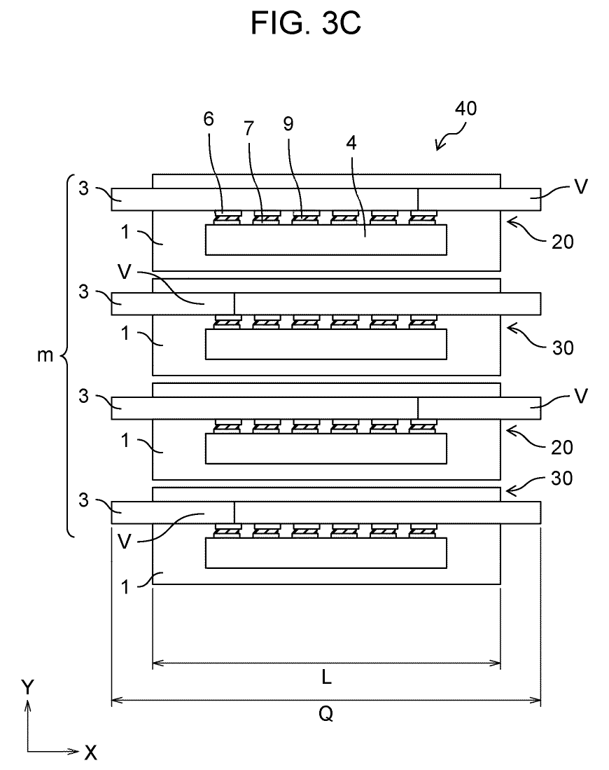

Next, array antenna structure 40 of the present first exemplary embodiment will be described with reference to FIGS. 3A to 3C.

As illustrated in FIGS. 3A to 3C, array antenna structure 40 of the present first exemplary embodiment is configured by alternately arranging, in the Y direction, m first antenna structures 20 each having notch V cut out by a length R in the X direction and a length S in the Z direction on the right side with respect to center line A-A’ in the X direction of power supply control board 3 and m second antenna structures 30 each having notch V cut out by a length R in the X direction and a length S in the Z direction on the left side with respect to center line A-A’ in the X direction of power supply control board 3. m is an integer of 2 or more.

In such an arrangement, as illustrated in FIGS. 3B and 3C, antenna structures 20 and 30 are arranged such that the positions of the board end portions of power supply control board 3 in the X direction are aligned.

Note that antenna boards 1 of adjacent antenna structures 20 and 30 may be in contact with each other or may be separated without being in contact with each other.

In the present first exemplary embodiment, an example is shown in which the number of first antenna structures 20 and second antenna structures 30 alternately arranged is four, but an optimum number (m) of first antenna structures 20 and second antenna structures 30 may be fabricated according to the application of the antenna. When n patch antenna elements 2 are formed on antenna board 1, array antenna structure 40 having n×m patch antenna elements 2 is obtained.

Note that, in the present first exemplary embodiment, as illustrated in FIG. 3B, first antenna structures 20 and second antenna structures 30 are alternately arranged in a positional relationship in which interval P in the Y direction between patch antenna elements 2 respectively formed therein is 3.75 mm, which is a half wavelength of a communication frequency of 39 GHz.

As a result, small array antenna structure 40 in which n×m patch antenna elements 2 are arranged on the matrix at equal intervals at a half wavelength of the communication frequency is configured.

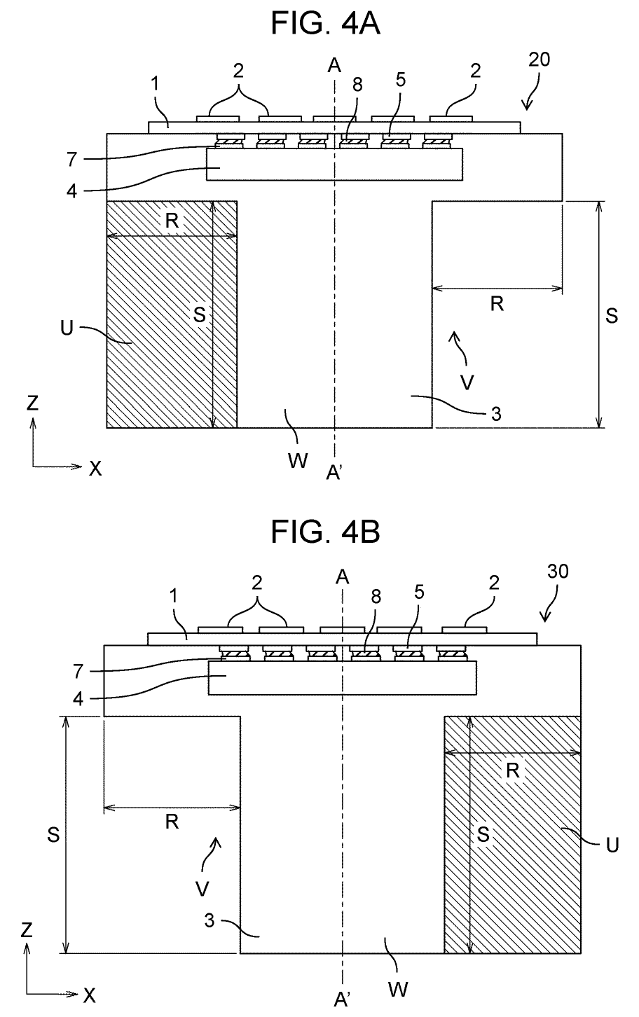

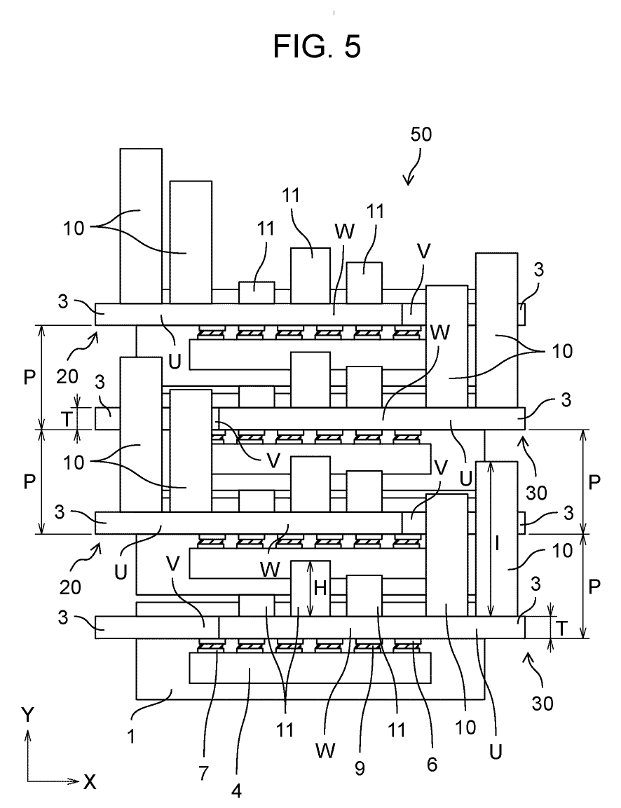

Next, the array antenna module according to the present first exemplary embodiment will be described with reference to FIGS. 4A, 4B, and 5.

FIG. 4A is a schematic diagram of first antenna structure 20 according to the first exemplary embodiment as viewed in the Y direction, and FIG. 4B is a schematic diagram of second antenna structure 30 according to the first exemplary embodiment as viewed in the Y direction.

FIG. 5 is a schematic diagram of array antenna module 50 according to the present first exemplary embodiment as viewed from the Z direction.

Here, the XZ region of each of power supply control boards 3 in FIGS. 4A to 5 is roughly divided into rectangular region of notch V, rectangular line-symmetric region U on the XZ region that is line-symmetric with respect to notch V and center line A-A’ in the X direction, and rectangular intermediate region W between the region of notch V and region U. Since intermediate region W of adjacent first or second antenna structure 20 or 30 is arranged to face intermediate region W, an electronic component having a relatively low height is arranged. On the other hand, since the region of notch V of adjacent first or second antenna structure 20 or 30 is arranged to face line-symmetric region U, an electronic component having a relatively high height that can penetrate the region of notch V can be arranged.

That is, in the array antenna structure in which first antenna structures 20 and second antenna structures 30 are alternately arranged at equal intervals P in the Y direction, electronic components 11 are mounted on intermediate region W in the XZ region of each power supply control board 3 of first antenna structure 20 and second antenna structure 30, electronic component 11 having a height larger than 0 and less than or equal to height H and satisfying the relational expression of 0 < H < P - T, that is, having a relatively low height.

In addition, in each of power supply control boards 3 of first antenna structure 20 and second antenna structure 30, electronic components 10 are mounted in line-symmetric region U on the XZ region that is line-symmetric with respect to the center line in the X direction with respect to notch V cut out by the length R in the X direction and the length S in the Z direction, electronic component 10 having a height larger than 0 and less than or equal to height I and satisfying the relational expression of 0 < I < 2P - T, that is, having a relatively high height.

In the case of array antenna module 50 of the present first exemplary embodiment, as an example, since the communication frequency is intended to be 39GHz, the interval P between first antenna structure 20 and second antenna structure 30 is 3.75 mm which is a half wavelength of the wavelength.

On the other hand, the components required to be mounted on power supply control board 3 constituting first antenna structure 20 and second antenna structure 30 include tall components having a thickness exceeding the interval P of 3.75 mm, such as a high-frequency control IC or a power supply control IC.

It is physically impossible to arrange such a component on intermediate region W of the XZ region between power supply control boards 3 in which the gap between first antenna structure 20 and second antenna structure 30 is only P-T.

However, if first antenna structures 20 and second antenna structures 30 are alternately arranged, and on region U on the XZ region of power supply control board 3 located in the space generated by notches V cut out by the length R in the X direction and the length S in the Z direction of power supply control board 3 being alternately located on the right side and the left side with respect to center line A-A’ in the X direction, the interval of the gap between first and second antenna structures 20 and 30 is 2P-T, and there is a margin in the mountable component height. Therefore, first and second antenna structures 20 and antenna structure 30 on which all necessary components are mounted on power supply control board 3 can be arranged at equal intervals P.

As a result, it is possible to realize small array antenna module 50 in which n×m patch antenna elements 2 are arranged on a matrix at equal intervals at a half wavelength of the communication frequency.

By using the structure according to the first exemplary embodiment of the present disclosure, even if a component having a thickness equal to or more than a half wavelength of the communication frequency is mounted on region U of power supply control board 3, notch V faces each region U and allows the component to be arranged without hindering the arrangement of the component, so that it is possible to provide small array antenna module 50 corresponding to high-frequency communication and having a structure in which patch antenna elements 2 are arranged on a matrix at equal intervals at a half wavelength of the communication frequency.

According to array antenna structure 40 and array antenna module 50 according to the first exemplary embodiment of the present disclosure, power supply control board 3 of first antenna structure 20 and power supply control board 3 of second antenna structure 30 are arranged such that each notch V faces the XZ region of adjacent power supply control board 3, and the arrangement of electronic components mounted in the XZ region is allowed without being hindered by adjacent power supply control boards 3. Therefore, it is possible to provide a small array antenna structure and array antenna module, the size of which is not restricted by the size or mounting area of the circuit components constituting the signal circuit or the power feed circuit.

That is, the interval at which antenna elements 2 are arranged, in other words, the thickness direction or the arrangement direction of first and second antenna structures 20 and 30 can be set as a direction intersecting with a direction affected by the size or the mounting area of the circuit component, for example, a direction orthogonal to the direction, so as not to be affected by the mounting area or the like.

Specifically, since the mounting area of the circuit components is along the XZ plane and is orthogonal to the Y direction which is the thickness direction of first and second antenna structures 20 and 30, the thickness direction is not affected by the mounting area or the like, and small first and second antenna structures 20 and 30 each having the mounting area less than or equal to the mounting area of the circuit component can be realized.

In addition, since the mounting area of the circuit components is along the XZ plane and is orthogonal to the Y direction which is the arrangement direction of first and second antenna structures 20 and 30, the arrangement direction is not affected by the mounting area or the like, and even in a case where array antenna structure 40 is formed by arranging a plurality of antenna elements 2, the interval at which the antenna elements 2 are arranged is not restricted by the mounting area or the like of the circuit components, and it is possible to realize array antenna structure 40 in which a plurality of small antenna elements 2 are arranged narrow and adjacent to each other.

Furthermore, when the antenna elements are arranged at an interval of a half wavelength of the communication frequency, for example, even in a case where high-frequency communication such as 39 GHz is required, that is, even when the half wavelength of the wavelength is a very small value, a plurality of antenna elements can be arranged at the half wavelength of the wavelength.

Note that by appropriately combining arbitrary exemplary embodiments or modifications among the various exemplary embodiments or modifications described above, the effects of the respective exemplary embodiments or modifications can be achieved. In addition, combinations of exemplary embodiments, combinations of examples, or combinations of exemplary embodiments and examples are possible, and combinations of features in different exemplary embodiments or examples are also possible.

### Supplementary note

The above description of the exemplary embodiments discloses the following techniques.

(Technique 1) An array antenna structure includes two or more m antenna structures including a first antenna structure and a second antenna structure, in which each of the first antenna structure and the second antenna structure is configured as an antenna structure in which an antenna board having n patch antenna elements formed in an X direction at an interval P, and having a length L in the X direction arranged on an XY plane, and a power supply control board having a length Q in the X direction and a thickness T arranged on an XZ plane are connected by a connection member including a joint electrode on a surface of an insulating resin such that a center line of each of the antenna board and the power supply control board in the X direction coincides with each other with the X direction as a longitudinal direction, the first antenna structure and the second antenna structure are arranged adjacent to each other in a Y direction of the XY plane, the power supply control board of the first antenna structure includes an L-shaped structure having a notch cut out by a length R in the X direction and a length S in the Z direction on a right side with respect to the center line in the X direction when viewed from the -Y direction, the power supply control board of the second antenna structure includes an L-shaped structure having a notch cut out by a length R in the X direction and a length S in the Z direction on a left side with respect to the center line in the X direction when viewed from the -Y direction, and the power supply control board of the first antenna structure and the power supply control board of the second antenna structure are arranged such that each notch faces an XZ region of an adjacent power supply control board.

(Technique 2) The array antenna structure according to Technique 1, in which the patch antenna elements of the first antenna structure and the patch antenna elements of the second antenna structure are arranged at an interval P in the Y direction.

(Technique 3) The array antenna structure according to Technique 2, in which the interval P is a half wavelength of a communication frequency.

(Technique 4) The array antenna structure according to any one of Techniques 1 to 3, in which the n patch antenna elements are formed line-symmetrically with respect to the center line of the antenna board in the X direction.

(Technique 5) The array antenna structure according to any one of Techniques 1 to 4, in which the length L and the length Q satisfy a relational expression of L = Q.

(Technique 6) An array antenna module, in which in the array antenna structure according to any one of Techniques 1 to 5, an electronic component having a height H or less is mounted on a third XZ region different from the first XZ region of the first power supply control board, and a relational expression of 0 < H < P - T is satisfied.

(Technique 7) The array antenna module according to Technique 6, in which an electronic component having a height I or less is mounted in a region that is line-symmetric with respect to the notch on the XZ region and the center line in the X direction, and a relational expression of 0 < I < 2P - T is satisfied.

According to each of the above Techniques, the power supply control board of the first antenna structure and the power supply control board of the second antenna structure are arranged such that each notch faces the XZ region of the adjacent power supply control board, and the arrangement of the electronic components mounted in the XZ region is allowed without being hindered by the adjacent power supply control board. Therefore, it is possible to provide a small array antenna structure and array antenna module, the size of which is not restricted by the size or mounting area of the circuit components constituting the signal circuit or the power feed circuit.

According to the array antenna structure and the array antenna module according to the aspect of the present disclosure, the power supply control board of the first antenna structure and the power supply control board of the second antenna structure are arranged such that each notch faces the XZ region of the adjacent power supply control board, and the arrangement of the electronic components mounted in the XZ region is allowed without being hindered by the adjacent power supply control board. Therefore, it is possible to provide a small array antenna structure and array antenna module, the size of which is not restricted by the size or mounting area of the circuit components constituting the signal circuit or the power feed circuit.

### INDUSTRIAL APPLICABILITY

According to the array antenna structure and the array antenna module according to the aspect of the present disclosure, it is possible to provide a small array antenna structure and array antenna module compatible with high-frequency communication, the size of which is not restricted by the size or mounting area of circuit components constituting a signal circuit or a power feed circuit.

### REFERENCE MARKS IN THE DRAWINGS

1 antenna board

2 patch antenna element

3 power supply control board

4 connection member

5 joint electrode

6 joint electrode

7 joint electrode

8 first joining part

9 second joining part

10 electronic component

11 electronic component

20 antenna structure

30 antenna structure

40 array antenna structure

50 array antenna module

U line-symmetric region

V notch

W intermediate region

1. An array antenna structure, comprising:
two or more m antenna structures including a first antenna structure and a second antenna structure, wherein
each of the first antenna structure and the second antenna structure is configured as an antenna structure in which an antenna board having n patch antenna elements formed in an X direction at an interval P, and having a length L in the X direction arranged on an XY plane, and a power supply control board having a length Q in the X direction and a thickness T arranged on an XZ plane are connected by a connection member including a joint electrode on a surface of an insulating resin such that a center line of each of the antenna board and the power supply control board in the X direction coincides with each other with the X direction as a longitudinal direction,
the first antenna structure and the second antenna structure are arranged adjacent to each other in a Y direction of the XY plane,
the power supply control board of the first antenna structure includes an L-shaped structure having a notch cut out by a length R in the X direction and a length S in the Z direction on a right side with respect to the center line in the X direction when viewed from a -Y direction,
the power supply control board of the second antenna structure includes an L-shaped structure having a notch cut out by a length R in the X direction and a length S in the Z direction on a left side with respect to the center line in the X direction when viewed from the -Y direction, and
the power supply control board of the first antenna structure and the power supply control board of the second antenna structure are arranged such that each notch faces an XZ region of an adjacent power supply control board.

2. The array antenna structure according to claim 1, wherein the patch antenna elements of the first antenna structure and the patch antenna elements of the second antenna structure are arranged at an interval P in a Y direction.

3. The array antenna structure according to claim 2, wherein the interval P is a half wavelength of a communication frequency.

4. The array antenna structure according to claim 1, wherein the n patch antenna elements are formed line-symmetric with respect to the center line of the antenna board in the X direction.

5. The array antenna structure according to claim 1, wherein the length L and the length Q satisfy a relational expression of L = Q.

6. An array antenna module, wherein
in the array antenna structure according to claim 1,
an electronic component having a height H or less is mounted on the XZ region of the power supply control board, and
a relational expression of 0 < H < P - T is satisfied.

7. The array antenna module according to claim 6, wherein
an electronic component having a height I or less is mounted in a region that is line-symmetric with respect to the notch on the XZ region and the center line in the X direction, and
a relational expression of 0 < I < 2P - T is satisfied.
